(19) United States
(12) Patent Application Publication
(10) Pub. No.: US 2009/0248289 A1
(43) Pub. Date: Oct. 1, 2009

(54) Apparatus for providing guidance route

(75) Inventors: Hiroshi Tanaka, Kariya-city (JP); Katsuhiro Ina, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/379,328

(22) Filed: Feb. 19, 2009

(30) Foreign Application Priority Data
Mar. 7, 2008 (JP) 2008-57940

(51) Int. Cl. G01C 21/00

(52) U.S. Cl. 701/200

(57) ABSTRACT

A navigation apparatus determines an influence of a typhoon, and provides a selection of two routes towards a destination if the typhoon has a great influence exceeding an influence threshold. The two routes provided are, a stand-by route that waits the typhoon to pass by and a detour route that avoids the typhoon by making a detour without waiting. The two routes are respectively presented on a display screen, after calculation by a route calculation unit, with an expected arrival time to the destination, a travel distance to the destination, and a stand-by time (only for the stand-by route) with an assistance of a draw unit. The navigation apparatus thus provides a user with a re-calculated guidance route that does not unnecessarily increase the travel distance to the destination, without forcing the user to be involved in a driving under the influence of the typhoon.

### CROSS REFERENCE TO RELATED APPLICATION

The present application is based on and claims the benefit of priority of Japanese Patent Application No. 2008-57940, filed on Mar. 7, 2008, the disclosure of which is incorporated herein by reference.

### FIELD OF THE DISCLOSURE

The present disclosure generally relates to a navigation apparatus that has a re-route function for avoiding a bad weather without forcing an unnecessary detour.

### BACKGROUND INFORMATION

A conventional navigation apparatus disclosed in, for example, Japanese patent document JP-A-2003-121172 has a weather reporting function. The weather reporting function acquires weather information from a weather information center and stores the information in a work memory together with a current vehicle position and position detection time. When a user provides an instruction to display the weather information, the weather information with the vehicle position and the detection time is extracted from the work memory, and is displayed on a display unit according to a descending time order.

By using the above-described function disclosed in the patent document, a relative relationship between the travel of the vehicle and the change of the weather can be recognized. For example, the travel of rain clouds relative to the travel of the vehicle can be recognized by the above-described function, thereby enabling the user/driver to avoid the bad weather by adjusting a travel direction of the vehicle thereafter.

The conventional navigation apparatus for use in a vehicle calculates, as a guidance route, an optimum route to a destination from a current position and sets the guidance route, once the destination is input. However, the conventional navigation apparatus does not take weather information such as a typhoon or the like into consideration when it calculates the guidance route, thereby navigating the user into a bad weather area without noticing it in some cases.

According to a technique disclosed in Japanese patent document JP-A-2006-145473, the weather information is acquired and a bad weather area is set based on the weather information. The guidance route is thereby set to avoid the bad weather area, for reaching the destination without entering the bad weather area by mistake. Further, according to techniques disclosed in Japanese patent documents JP-A-2003-294470 and JP-A-2002-206936, the weather information is considered in addition to traffic information and map data for providing route information regarding the guidance route for the user.

However, the technique employed by the conventional navigation apparatus calculates and sets a longer guidance route depending on a size and speed of the typhoon, thereby making the guidance route having an increased travel distance in comparison to the original guidance route.

### SUMMARY OF THE DISCLOSURE

In view of the above and other problems, the present disclosure provides a navigation apparatus for use in a vehicle that prevents an increase of a travel distance due to an unnecessary detour by ‘re-routing’ a guidance route, possibly with a stand-by instruction, still without forcibly navigating the vehicle and the driver along a weather influenced guidance route while the guidance route is under the influence of a bad weather.

In an aspect of the present disclosure, the navigation apparatus acquires weather information, and sets an avoidable area that is under the influence of, for example, a weather phenomenon, such as a bad weather including a typhoon or the like, based on the weather information. The avoidable area is set to include a predicted course of the weather, that is, the typhoon or the like. In other words, the avoidable area extends along the predicted course of the typhoon, for example, with an influenced area having a certain breadth. Then, the navigation apparatus determines whether or not an original guidance route to a destination of the travel calculated by the apparatus is included at least partially in the avoidable area. If the original route is included in the avoidable area, the apparatus calculates and presents, for the user, two alternative routes, that is, (a) a stand-by route that uses the original guidance route with a stand-by for allowing the typhoon to move away from the original guidance route, and (b) a detour route that sets a new guidance route going around the avoidable area. Then, the user selects one of the two alternatives to continue the travel to the destination. As a result, by providing route guidance to prompt the user to wait for a certain period of time on stand-by, the user can let, for example, the typhoon go by before resuming the travel to the destination, without unnecessarily increasing the travel distance, and without being forced to go through the weather influenced area.

Further, in another aspect of the disclosure, the user can put the waiting time into effective use by dropping at, for example, the nearest gas station along the original route or the like based on the information provided by the navigation apparatus in case that the stand-by route is selected.

Further, in yet another aspect of the disclosure, the user can safely resume the travel after confirming the passing of the bad weather, because of a confirmation notification from the apparatus that the stand-by route is no longer under the influence of the bad weather, that is, the guidance route has taken off from the typhoon.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of an operation scheme of the present disclosure including a navigation apparatus and a weather information center;

FIG. 2 is a flow chart of route guide processing;

FIG. 3 is an illustration of a calculated guidance route without consideration for a typhoon-influenced area;

FIG. 4 is an illustration of a calculated guidance route with consideration for the typhoon-influenced area that serves as a detour route; and

FIG. 5 is an illustration of a calculated guidance route with consideration for the typhoon-influenced area that serves as a stand-by route.

### DETAILED DESCRIPTION

The embodiment of the present invention is described in the following with reference to the drawings.

### First Embodiment

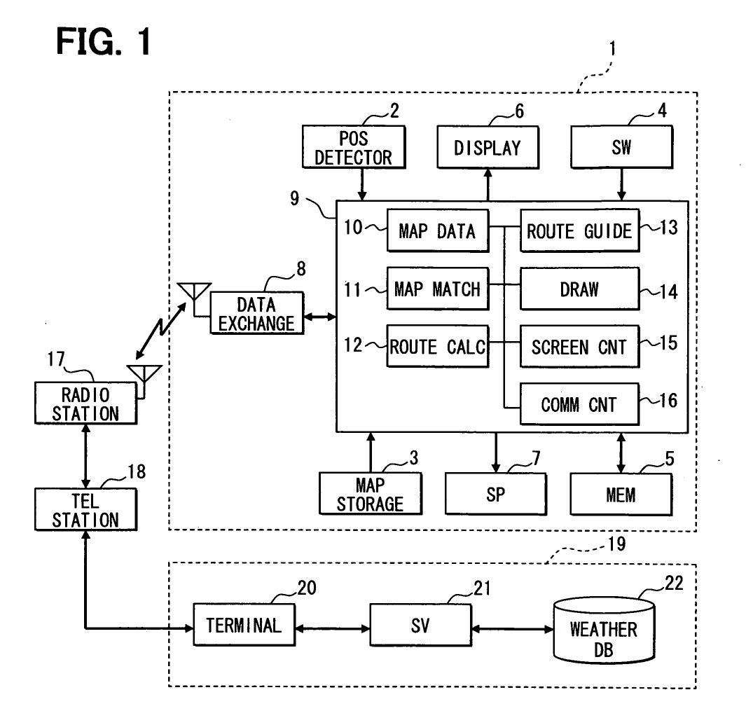

FIG. 1 is a function block diagram including a vehicle navigation apparatus 1 and a weather information center 19. The description in the following explains the vehicle navigation apparatus 1 first, and then explains the weather information center 19.

### Explanation of Configuration of the Vehicle Navigation Apparatus

The vehicle navigation apparatus 1 has a positional detection unit 2, a map data storage unit 3, a switch information input unit 4, a memory 5, a display 6, a voice output unit 7, a data exchange unit 8, and a control unit 9 to which each of those units is connected.

### Explanation of Configuration of the Positional Detection Unit

The positional detection unit 2 has a geo-magnetism sensor, a gyroscope, a distance sensor, and a GPS (Global Positioning System) receiver for receiving GPS signal from satellites and for detecting a current position of the vehicle, all of which are well-known, conventional type. These sensors have errors of respectively different nature, and are configured to compensate with each other for the improvement of the accuracy. These sensors may further be compensated with other sensors such as a steering wheel rotation sensor, tire sensors and the like, or only a part of these sensors may selectively be used, depending on the required accuracy.

### Explanation of Configuration of the Map Data Storage Unit

The map data storage unit 3 is composed of a CD-ROM, a DVD-ROM, a memory card, an HDD, and the like, for storing various data including data for a so-called map matching for the accuracy improvement of the position detection and tracking, map data, and sign data.

### Explanation of Configuration of the Switch Information Input Unit

The switch information input unit 4 has a touch switch that is formed on the display 6, a mechanical switch or the like, for inputting, to the control unit 9, operation instructions of various functions (For instance, map scale change, menu display selection, destination setting, route search, route guide start, current location correction, display screen change, volume adjustments and the like) according to the operation of the switch.

The switch information input unit 4 may be composed by a remote control terminal (designated as a remote controller hereinafter), and send and receive information to/from the control unit 9 through wireless communication. When the destination is set by the switch information input unit 4, the control unit 9 automatically searches for an optimum route to the destination from the current position based on the information from the positional detection unit 2, and displays the searched route. The technique such as the Dijkstra method or the like is known as a technique for automatically setting the optimum route. The searched and set route is displayed on top of a map that is generated by the information acquired from the map data storage unit 3, together with a current position mark according to the information from the positional detection unit 2. In addition, other information such as a current time, congestion information, etc. can be displayed on the display 6 besides the current vehicle position and the guidance route.

### Explanation of Configuration of the Memory

The memory 5 has data storage such as a ROM, a RAM, for example. The ROM stores, for example, a navigation program for performing navigation operation, and the RAM temporarily stores map data retrieved from the map data storage unit 3 and the like as well as work data for executing the navigation program.

### Explanation of Configuration of the Display

The display 6 is a display apparatus for displaying a map, a destination setting screen of navigation operation and the like, and is capable of displaying a full-color image by using a liquid crystal, an organic EL, etc. as its component.

### Explanation of Configuration of the Voice Output Unit

The voice output unit 7 consists of a speaker, and provides voice output for the guidance and for the explanation of the screen operation.

### Explanation of Configuration of the Data Exchange Unit

The data exchange unit 8 has an intercommunication function by using, for example, a cellular-phone, an automobile phone or the like, and is connected to the control unit 9 in an easily-detachable manner. The connection between the exchange unit 8 and the control unit 9 may or may not be configured as easily-detachable in this case.

### Explanation of Configuration of the Control Unit

The control unit 9 has a map data acquisition unit 10, a map matching unit 11, a route calculation unit 12, a route guide unit 13, a draw unit 14, a screen control unit 15, and a communication control unit 16 mutually connected through a bus line. Each of those units is described in the following in order.

The map data acquisition unit 10 acquires required map data from the map data storage unit 3 for processing in each of those units 11, 12, 13, 14, 15, and 16, and provides the data thereto. Further, each processing is executed by using the ROM and RAM of the memory 5.

The map matching unit 11 determines on which road the current position is based on the road shape data and the like in the map data acquired from the map data storage unit 3 as well as the position information detected by the positional detection unit 2. In this case, the required map data is retrieved from the map data storage unit 3 by the map data acquisition unit 10.

In the route calculation unit 12, processing such as displaying a desired position on the map by using the current position information calculated in the map matching unit 11 and a start point specified by the user, as well as an input from the switch information input unit 4 for calculating the route to the specified destination.

In the route guide unit 13, guidance points are calculated based on the route calculation results together with the road shape data in the map data and intersection position data, railway crossing position data or the like, and required guidance such as turning right/left or the like are prepared.

In the draw unit 14, a map of the current position as well as a schematic map of expressways, an expanded view of an intersection and the like are drawn according to the instruction from the screen control unit 15 to be displayed on the display 6. The screen control unit 15 instructs the draw unit 14 to draw a screen image on the display 6.

In the communication control unit 16, instructions from the user by using the switch information input unit 4 are processed, and intercommunication through the data exchange unit 8 at a regular interval is controlled. Further, by sending a weather information request through the data exchange unit 8, the control unit 9 acquires the weather information from the weather information center 19.

### The Weather Information Center

The weather information center 19 has a connection line terminal equipment 20 for communication through a telephone station 18 as well as a server 21 for processing the weather information and a database 22 for storing the weather information. The weather information center 19 is connected to a radio station 17 through the telephone station 18 for data communication between the vehicle navigation apparatus 1 and the radio station 17.

### Explanation of Route Guide Processing

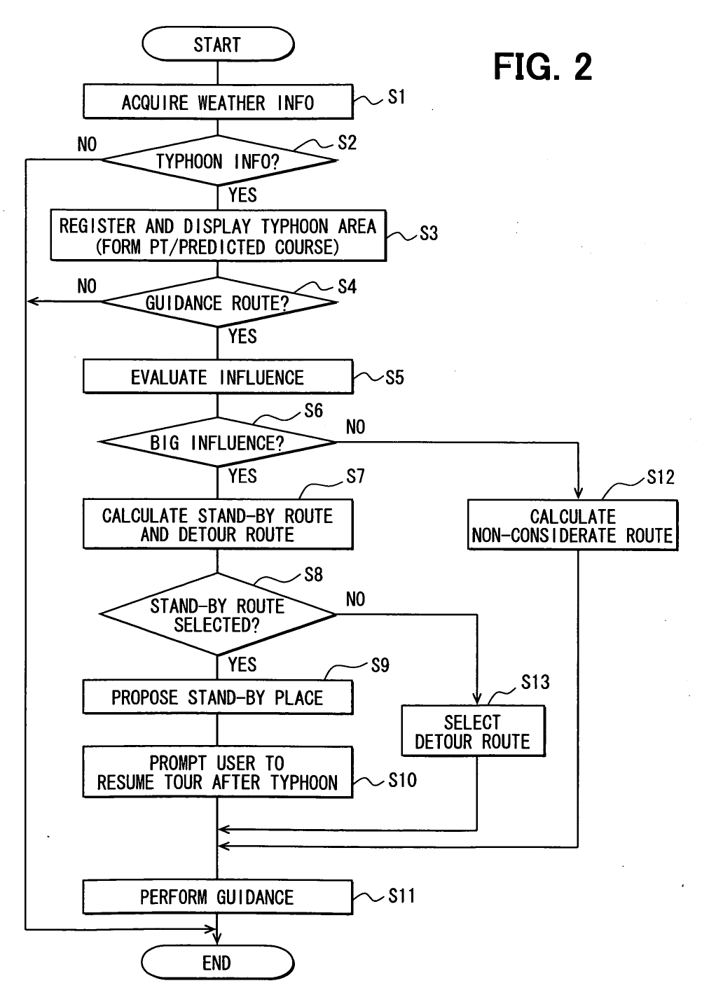

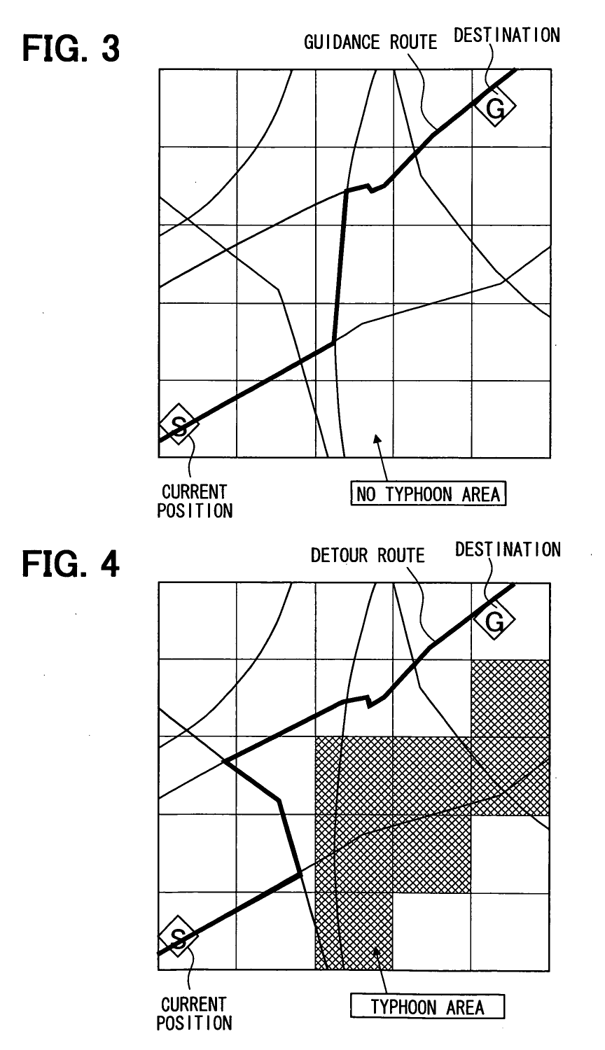

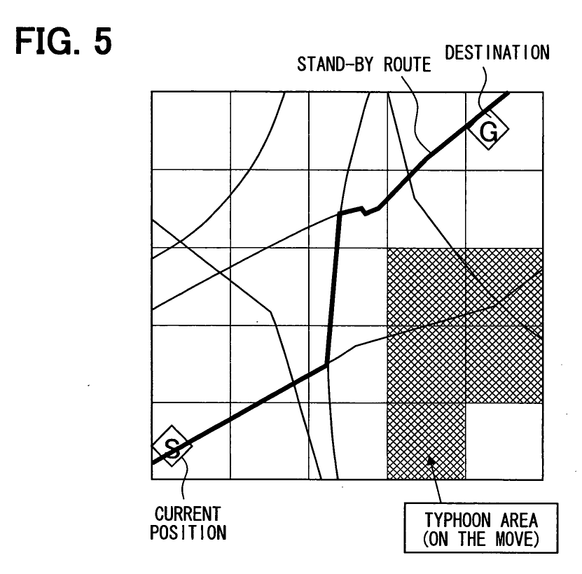

The route guide processing performed by the control unit 9 is described with reference to a flow chart in FIG. 2 and illustrations in FIGS. 3 to 5. The example illustration in FIG. 3 shows a guidance route calculated without considering a typhoon area, and the example illustration in FIG. 4 shows a detour route that avoids the typhoon by considering the typhoon area. The example illustration in FIG. 5 is a stand-by route that waits the passing-by of the typhoon by considering the typhoon area.

The route guide processing is executed independently from the other processings executed by the control unit 9.

The route guide processing starts when the ignition of the vehicle is turned on and the electric power is supplied to the navigation apparatus, the power supply is turned on to the vehicle navigation apparatus 1. Next, the control unit 9 of the vehicle navigation apparatus 1 accesses the weather information center 19 through the data exchange unit 8 and through the radio station 17 and the telephone station 18, and acquires the weather information (S1). Then, in S2, whether there is typhoon information in the acquired information is examined.

If there is no typhoon information in the weather information (S2: NO), the process concludes itself without going any further. If there is the typhoon information found in the weather information (S2: YES), a typhoon area (i.e., an avoidable area) including a current position of the typhoon as well as a formation position and a predicted course are registered, and the screen control unit 15 is used to display the typhoon area, that is, the area of bad weather under the influence of the typhoon (refer to FIGS. 3 and 5). In this case, a predicted course of the typhoon may also be displayed on the map.

If the destination has not been set by the user and the guidance route to the destination has not been displayed on the display 6 (S4: NO), the process concludes itself without going any further. If the destination has been set by the user and the guidance route to the destination is displayed on the display 6 (S4: YES), the route calculation unit 12 calculates the influence of the typhoon based on the weather information. The influence of the typhoon is calculated by considering a travel time for passing through the typhoon area as well as a travel distance when the vehicle follows the guidance route, and by also considering the wind speed, the atmospheric pressure, the wind direction and the like of the typhoon (S5). More practically, the travel time and the travel distance in the typhoon area, as well as the wind speed/the atmospheric pressure/the wind direction in the typhoon area are respectively compared with a threshold, and the number of the items exceeding the threshold is used as an indicator of typhoon influence level. Each of the items may be weighted by a weighting factor, and the weighting factors may be changed according to the time of the day and the time range. In this case, the influence level may be calculated for each of the grid areas on the map, and the guidance route may be calculated to avoid the high influence level area.

Then, the calculated influence level of the typhoon is evaluated (S6). If the influence level is equal to or smaller than an influence threshold, the influence on the guidance route is considered as small (S6: NO), and the guidance route is calculated without consideration for the typhoon area by using the route calculation unit 12. The calculated route is presented for the user (S12) as shown in FIG. 3, and the route guidance is started by using the route guide unit 13 (S11).

On the other hand, if it is determined that the influence level of the typhoon to the guidance route is greater than the influence threshold, the influence of the typhoon on the guidance route is considered as big (S6: YES). Then, (a) a stand-by route that uses the original guidance route and waits for the typhoon to pass by and (b) a detour route that goes around the typhoon without waiting are respectively calculated by using the route calculation unit 12. Then, the two routes are displayed on the display 6 together with the expected arrival time to the destination, the travel distance to the destination and the wait time for waiting the typhoon to pass-by (only for the stand-by route) associated with the routes by using the draw unit 14 (S7).

Then, the user is allowed to select from among two routes, whether to wait for the typhoon passage in the stand-by route, or to go without waiting for the typhoon passage in the detour route (S8). If the stand-by route is selected by the user (S8: YES), the available facility that can be dropped by during the waiting time is displayed as recommendation (i.e., a stand-by place) for the user from the map data acquisition unit 10 (S9). More practically, in this case, facilities such as a road-side travel station, a convenience store, a book store, a gas station and a pinball parlor may be recommended and proposed to the user. Then, after confirming that the typhoon has passed by, a message that prompts the user to resume the travel to the destination is displayed on the display 6 at an appropriate start time (S10), and the route guidance is provided from the route guide unit 13 as shown in FIG. 5 (S11).

On the other hand, if the detour route is selected by the user (S8: NO), the user is notified that the detour route is used due to the closeness to the typhoon (S13) and the route guidance is provided from the route guide unit 13 as shown in FIG. 4 (S11).

When the route guidance in the above-mentioned S11 is concluded, the route guide processing is concluded.

### Advantageous Effects of the First Embodiment

(1) In the navigation apparatus 1 in the first embodiment, the guidance route to the destination is calculated as the stand-by route for waiting for passing by of the typhoon, and the detour route is calculated for going around the typhoon without waiting, respectively by the route calculation unit 12, and the two calculated routes are presented for the user through the draw unit 14 when the influence of the typhoon is determined as big (S6: YES). Each of the two routes are provided with the arrival time, the travel distance, and the wait time (only for the detour route) displayed on the display 6 (S7). Then, the route guidance is continued by using the selected route (S11). Therefore, only by waiting for a certain period of time to let the bad weather such as a typhoon pass by, the user is prompted and guided to resume the travel without increasing the travel distance unnecessarily, and without being forced into the travel that comes under the influence of the bad weather.

(2) Moreover, in the first embodiment, the waiting time is effectively utilized by the user due to the facility guide provided by the navigation apparatus 1 (S9) when the stand-by route is selected by the user (S8: YES).

(3) Further, in the first embodiment, when the stand-by route is selected (S8: YES), the navigation apparatus 1 prompts the user at an appropriate travel start time (S10) to resume the travel by the message displayed on the display 6 of the navigation apparatus 1 after confirmation of the passing-by of the typhoon, thereby enabling the user to safely continue the travel after avoiding the bad weather.

### Other Embodiments

Although the present disclosure has been fully described in connection with preferred embodiment thereof with reference to the accompanying drawings, it is to be noted that various changes and modifications will become apparent to those skilled in the art.

For example:

(1) The typhoon area may be set to the current typhoon position only, without including the predicted course or the like.

(2) The weather information may be regularly acquired from the weather information center 19 at a predetermined interval.

(3) The acquisition of the weather information may be triggered by a reception of a weather information notification start signal from the weather information center 19 by the data exchange unit 8.

(4) The weather information may be acquired by a radio, a television or the like, if the radio/television is connected to the navigation apparatus 1 by a LAN in the vehicle.

(5) The weather information such as rain cloud information for warning a heavy rain, thunderstorm information, hurricane information or the like may also be utilized to set the avoidable area besides the typhoon information. Particularly, the hurricane information that predicts the arrival of the hurricane may be acquired in advance, and the information contents such as the current position, the predicted course, the size and the like may be utilized for preparing and/or avoiding the hurricane. In addition, the information may be periodically checked in terms of its freshness, and the information may be updated to the latest one when it is determined as old.

Such changes, modifications, and operation schemes are to be understood as being within the scope of the present disclosure as defined by appended claims.

What is claimed is:

1. A navigation apparatus capable of setting a guidance route to a destination, the apparatus for use in a vehicle comprising:
a weather information acquisition unit for acquiring weather information; and
an avoidable area setting unit for setting an avoidable area under influence of a weather phenomenon that exists in a proximity of the guidance route currently being set based on the weather information acquired by the weather information acquisition unit, wherein
a coverage of the avoidable area extends along a predicted course of the weather phenomenon based on the acquired weather information, and
when the guidance route is at least partially included in the avoidable area, the guidance route is altered to one of (a) a stand-by route that uses the guidance route currently being set with a stand-by for waiting the guidance route to take off from the avoidable area, and (b) a detour route that sets a detour from the guidance route for avoiding the avoidable area, according to a selection input after calculating and presenting a selector with both routes.

2. The navigation apparatus of claim 1, wherein
facility information about facilities existing along the stand-by route is provided when the stand-by route is set as the guidance route.

3. The navigation apparatus of claim 1, wherein
a confirmation notification is provided as a confirmation of the stand-by route having taken off from the avoidable area when the stand-by route is set as the guidance route.
